(19) United States
(12) Patent Application Publication
(10) Pub. No.: US 2025/0187048 A1
(43) Pub. Date: Jun. 12, 2025

(54) Pipe Clog-Clearing Device

(71) Applicant: Petros Nalchadzhyan, Glendale, CA (US)

(72) Inventor: Petros Nalchadzhyan, Glendale, CA (US)

(21) Appl. No.: 18/912,710

(22) Filed: Oct. 11, 2024

Related U.S. Application Data
(60) Provisional application No. 63/607,645, filed on Dec. 8, 2023.

(51) Int. Cl. B08B 9/051; B26D 3/08

(52) U.S. Cl. CPC B08B 9/051; B26D 3/08; B08B 2209/04

(57) ABSTRACT

A pipe clog-clearing device is provided. The device is comprised of a cylindrical body with couplings at each end for attachment to pipe systems. Inside the body is at least one blade with a cutting edge, made from metal or plastic, which rotates 360 degrees around an axle. The rotation is powered by a motor to break up and clear blockages within the pipe system. The motor can be controlled by a timer for automatic operation at set intervals, or remotely via a wireless receiver communicating with a remote or a mobile application on a smart device.

### CROSS-REFERENCE TO RELATED APPLICATION

The present application claims priority to, and the benefit of, U.S. Provisional Application No. 63/607,645, which was filed on Dec. 8, 2023, and is incorporated herein by reference in its entirety.

### FIELD OF THE INVENTION

The present invention relates generally to the field of pipe-clearing devices. More specifically, the present invention relates to a pipe clog-clearing device that attaches to a pipe system, featuring a blade inside that rotates 360 degrees to break up and clear blockages. The device's blade rotation is powered by an electric motor, which can be controlled remotely via a timer, wireless remote, or mobile application for manual activation or programmed operation. Accordingly, the present disclosure makes specific reference thereto. Nonetheless, it is to be appreciated that aspects of the present invention are also equally applicable to other like applications, devices, and methods of manufacture.

### BACKGROUND

Plumbing pipes are prone to becoming clogged over time, which can lead to highly undesirable plumbing backups, which not only cause inconvenience but can also result in significant damage to the property and potential health hazards. Such clogs are commonly caused by the accumulation of materials such as hair, grease, food particles, and other debris that gradually build up and obstruct the flow of water.

To address these clogs, common tools such as drain cleaners and plumbing snakes (also known as augers) are often employed. Drain cleaners, available in chemical or natural formulations, are designed to dissolve or break down the materials causing the blockage. Plumbing snakes, on the other hand, are flexible and long tools used to physically dislodge clogs that are further down the pipe.

However, there are instances where these methods may not be entirely effective in removing the blockage within a pipe. For instance, the blockage might be too solid or too far along the pipe for a drain cleaner to be effective. In the case of chemical cleaners, there is also the risk of damaging the pipes if they are used excessively or improperly. Plumbing snakes, while useful, might not be able to reach or break apart all types of clogs, especially those that are exceptionally large, solidified, or deeply lodged within the plumbing system.

Moreover, the use of these tools requires a certain level of skill and knowledge. Improper use can lead to further damage to the plumbing system, such as pipe breakage or worsening of the clog. This is particularly the case in older plumbing systems, where pipes might be more fragile or susceptible to damage. Accordingly, while drain cleaners and plumbing snakes are valuable tools for addressing immediate clogging issues, they may not always provide a permanent solution.

Therefore, there exists a long-felt need in the art for an improved pipe de-clogging device. There also exists a long-felt need in the art for a pipe clog grinder device. More specifically, there exists a long-felt need in the art for a pipe clog grinder device that removes clogs within pipes via an improved and easy-to-use removal process.

The subject matter disclosed and claimed herein, in one embodiment thereof, comprises a pipe clog-clearing device. The device is comprised of a cylindrical body with couplings at each end for attachment to pipe systems. Inside the body is at least one blade with a cutting edge, made from metal or plastic, which rotates 360 degrees around an axle. The rotation is powered by a motor to break up and clear blockages within the pipe system. The motor can be controlled by a timer for automatic operation at set intervals, or remotely via a wireless receiver communicating with a remote or a mobile application on a smart device.

In this manner, the pipe-clog-clearing device of the present invention accomplishes all the forgoing objectives and provides an improved pipe-clogging device. More specifically, the device removes clogs within pipes via an improved and easy-to-use removal process. Further, said process does not require any substantial level of skill or knowledge to operate.

### SUMMARY

The following presents a simplified summary to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a pipe clog-clearing device. The device can attach to a pipe system on both ends such that the device is in fluid communication with the pipe system via at least one opening of each end. As a result, at least one blade can be activated to break up/clear debris or clogs within the pipe system. Both ends are comprised of at least one coupling of any style of pipe coupling known in the art.

The interior space of the body is comprised of at least one blade with at least one cutting edge. The blade rotates around at least one axle. More specifically, the blade can rotate 360 degrees around the axle relative to the vertical axis of the body. Rotation of the axle (and blade) is done by at least one motor. As a result, the rotation of the blade breaks up and/or clears blockages within the body, ensuring the blockage does not disrupt the pipe system the device is installed to.

In one embodiment, the motor is comprised of a timer that activates the motor to spin the axle (and thus blade) at a programmable time interval such as but not limited to once an hour, once a day, once a week, once a month, etc. In a different embodiment, the motor can be remotely activated. In a further embodiment, the motor can be activated/programmed by at least one mobile application.

The present invention is also comprised of a method of using the device. First, a device is provided comprised of a body comprised of a first end comprised of at least one coupling, a second end comprised of at least one coupling, an interior space comprised of at least one blade, and at least one motor. Then, the first end and second end can be attached in line with a pipe system (via the couplings) such that the body is in fluid communication with the pipe system. Then, the motor can be programmed to spin the blade during specific time intervals via at least one timer of the motor.

The present invention is also comprised of a second method of using the device. First, a device is provided comprised of a body comprised of a first end comprised of at least one coupling, a second end comprised of at least one coupling, an interior space comprised of at least one blade, at least one motor, and at least one remote. Then, the first end and second end can be attached in line with a pipe system (via the couplings) such that the body is in fluid communication with the pipe system. Then, the motor can be activated and/or programmed to spin the blade during specific time intervals via the remote.

The present invention is also comprised of a third method of using the device. First, a device is provided comprised of a body comprised of a first end comprised of at least one coupling, a second end comprised of at least one coupling, an interior space comprised of at least one blade, at least one motor, and at least one mobile application. Then, the first end and second end can be attached in line with a pipe system (via the couplings) such that the body is in fluid communication with the pipe system. Then, the motor can be activated and/or programmed to spin the blade during specific time intervals via the mobile application.

Accordingly, the pipe clog-clearing device of the present invention is particularly advantageous as it provides an improved pipe-de-clogging device. More specifically, the device removes clogs within pipes via an improved and easy-to-use removal process. Further, said process does not require any substantial level of skill or knowledge to operate. In this manner, the pipe clog-clearing device overcomes the limitations of existing pipe de-clogging devices known in the art.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one potential embodiment of a pipe clog-clearing device of the present invention in accordance with the disclosed architecture;

FIG. 2 illustrates a perspective top view of one potential embodiment of a pipe clog-clearing device of the present invention in accordance with the disclosed architecture;

FIG. 3 illustrates a front view of a remote of one potential embodiment of a pipe clog-clearing device of the present invention in accordance with the disclosed architecture;

FIG. 4 illustrates a flowchart of a method of using one potential embodiment of a pipe clog-clearing device of the present invention in accordance with the disclosed architecture;

FIG. 5 illustrates a flowchart of a method of using one potential embodiment of a pipe clog-clearing device of the present invention in accordance with the disclosed architecture; and

FIG. 6 illustrates a flowchart of a method of using one potential embodiment of a pipe clog-clearing device of the present invention in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth to provide a thorough understanding thereof. It may be evident, however, that the innovation can be practiced without these specific details. In other instances, well-known structures and devices are shown in block diagram form to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for an improved pipe de-clogging device. There also exists a long-felt need in the art for a pipe clog grinder device. More specifically, there exists a long-felt need in the art for a pipe clog grinder device that removes clogs within pipes via an improved and easy-to-use removal process.

The present invention, in one exemplary embodiment, is comprised of a pipe clog-clearing device that can attach to a pipe system on both ends such that the device is in fluid communication with the pipe system via at least one opening of each end. As a result, at least one blade can be activated to break up/clear debris or clogs within the pipe system. Both ends are comprised of at least one coupling of any style of pipe coupling known in the art.

The interior space of the body is comprised of at least one blade with at least one cutting edge that rotates around at least one axle. More specifically, the blade can rotate 360 degrees around the axle relative to the vertical axis of the body. Rotation of the axle (and blade) is done by at least one motor such that rotation of the blade breaks up and/or clears blockages within the body, ensuring the blockage does not disrupt the pipe system the device is installed to.

In one embodiment, the motor is comprised of a timer that activates the motor to spin the axle (and thus blade) at a programmable time interval such as but not limited to once an hour, once a day, once a week, once a month, etc. In a different embodiment, the motor can be remotely activated. In a further embodiment, the motor can be activated/programmed by at least one mobile application.

The present invention is also comprised of a method of using the device. First, a device is provided comprised of a body comprised of a first end comprised of at least one coupling, a second end comprised of at least one coupling, an interior space comprised of at least one blade, and at least one motor. Then, the first end and second end can be attached in line with a pipe system (via the couplings) such that the body is in fluid communication with the pipe system. Then, the motor can be programmed to spin the blade during specific time intervals via at least one timer of the motor.

The present invention is also comprised of a second method of using the device. First, a device is provided comprised of a body comprised of a first end comprised of at least one coupling, a second end comprised of at least one coupling, an interior space comprised of at least one blade, at least one motor, and at least one remote. Then, the first end and second end can be attached in line with a pipe system (via the couplings) such that the body is in fluid communication with the pipe system. Then, the motor can be activated and/or programmed to spin the blade during specific time intervals via the remote.

The present invention is also comprised of a third method of using the device. First, a device is provided comprised of a body comprised of a first end comprised of at least one coupling, a second end comprised of at least one coupling, an interior space comprised of at least one blade, at least one motor, and at least one mobile application. Then, the first end and second end can be attached in line with a pipe system (via the couplings) such that the body is in fluid communication with the pipe system. Then, the motor can be activated and/or programmed to spin the blade during specific time intervals via the mobile application.

Accordingly, the pipe clog-clearing device of the present invention is particularly advantageous as it provides an improved pipe-de-clogging device. More specifically, the device removes clogs within pipes via an improved and easy-to-use removal process. Further, said process does not require any substantial level of skill or knowledge to operate. In this manner, the pipe clog-clearing device overcomes the limitations of existing pipe de-clogging devices known in the art.

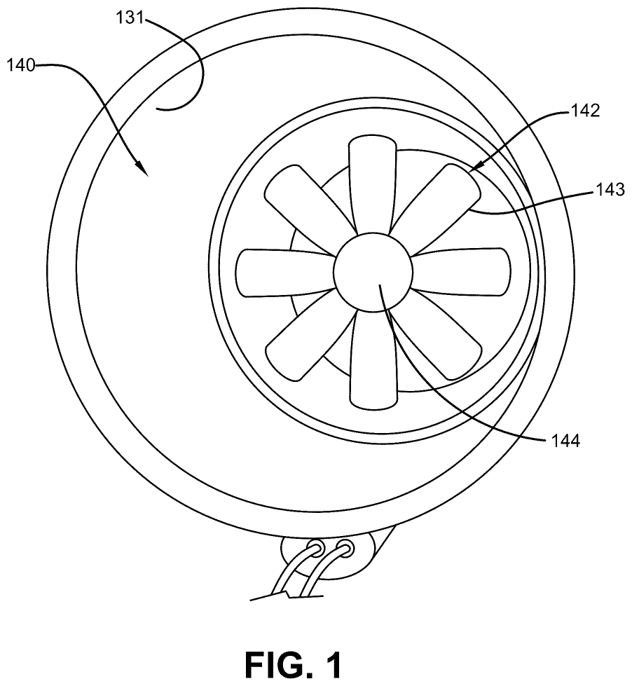

Referring initially to the drawings, FIG. 1 illustrates a perspective view of one potential embodiment of a pipe clog-clearing device 100 of the present invention in accordance with the disclosed architecture. The device 100 can attach to a pipe system on both ends 120,130 such that the device 100 is in fluid communication with the pipe system via at least one opening 121,131 of each end 120,130. As a result, at least one blade 142 can be activated to break up/clear debris or clogs within the pipe system.

The device 100 is comprised of a body 110. The body 110 is preferably cylindrical, but may be any shape. The body 110 is comprised of a first end 120 and a second end 130. Both ends are comprised of at least one coupling 122,132. The coupling 122,132 allows each end 120,130 to attach to a pipe of a pipe system. The coupling 122,132 may be any style of pipe coupling known in the art such as but not limited to a rigid coupling, a flexible coupling, a slip coupling, a compression coupling, a flange coupling, a sleeve coupling, a grooved coupling, a hydraulic coupling, a bell and spigot coupling, a union coupling, etc.

The interior space 140 of the body 110 is comprised of at least one blade 142. The blade 142 may be any shape, size, and blade configuration. The blade 142 may have at least one cutting edge 143. The blade 142 rotates around at least one axle 144. More specifically, the blade 142 can rotate 360 degrees around the axle 144 relative to the vertical axis of the body 110. The blade 142 is preferably made from a metal or plastic material.

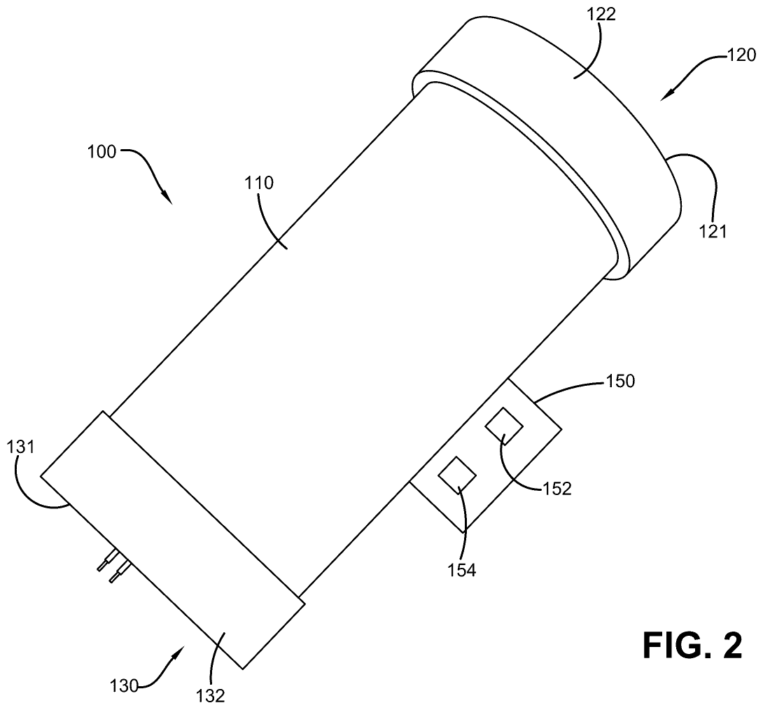

Rotation of the axle 144 (and blade 142) is done by at least one motor 150, as seen in FIG. 2. The motor 150 may be any type or configuration of motor 150. However, the motor 150 is preferably an electric motor. As a result, rotation of the blade 142 breaks up and/or clears blockages within the body 110, ensuring the blockage does not disrupt the pipe system the device 100 is installed to.

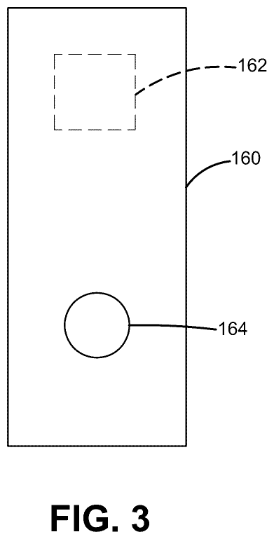

In one embodiment, the motor 150 is comprised of a timer 152. The timer 152 activates the motor 150 to spin the axle 144 (and thus blade 142) at a programmable time interval such as but not limited to once an hour, once a day, once a week, once a month, etc. In a different embodiment, the motor 150 can be remotely activated. In this embodiment, the motor 150 is comprised of at least one receiver 154 in wireless electrical communication with at least one transmitter 162 of at least one remote 160 (as seen in FIG. 3) via Wi-Fi, Bluetooth, RFID, etc. The remote 160 may be comprised of at least one button 164 that can be pressed to activate the motor 150. The button 164 may also allow a user to program a time interval for the motor 150 to run.

In a further embodiment, the motor 150 can be activated/programmed by at least one mobile application 170. The application 170 can be installed on a smart device such as but not limited to a smartphone, a tablet, a computer, etc. Said smart device is in wireless electrical communication with the receiver 154 of the motor 150. The application 170 allows a user to activate 172 the blade 142 as desired. The application 170 also allows a user to program a time interval 174 for the blade 142 to run.

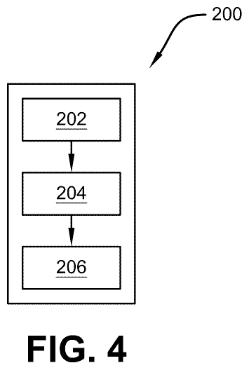

The present invention is also comprised of a method of using 200 the device 100, as seen in FIG. 4. First, a device 100 is provided comprised of a body 110 comprised of a first end 120 comprised of at least one coupling 122, a second end 130 comprised of at least one coupling 132, an interior space 140 comprised of at least one blade 142, and at least one motor 150 [Step 202]. Then, the first end 120 and second end 130 can be attached in line with a pipe system (via the couplings 122,132) such that the body 110 is in fluid communication with the pipe system [Step 204]. Then, the motor 150 can be programmed to spin the blade 142 during specific time intervals via at least one timer 152 of the motor 150 [Step 206].

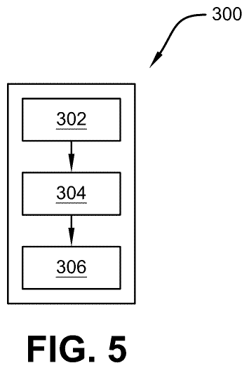

The present invention is also comprised of a second method of using 300 the device 100, as seen in FIG. 5. First, a device 100 is provided comprised of a body 110 comprised of a first end 120 comprised of at least one coupling 122, a second end 130 comprised of at least one coupling 132, an interior space 140 comprised of at least one blade 142, at least one motor 150, and at least one remote 160 [Step 302]. Then, the first end 120 and second end 130 can be attached in-line with a pipe system (via the couplings 122,132) such that the body 110 is in fluid communication with the pipe system [Step 304]. Then, the motor 150 can be activated and/or programmed to spin the blade 142 during specific time intervals via the remote 160 [Step 306].

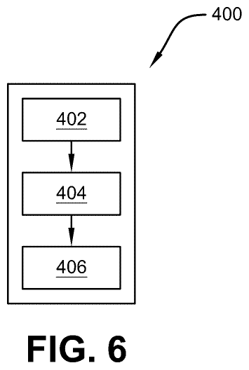

The present invention is also comprised of a third method of using 400 the device 100, as seen in FIG. 6. First, a device 100 is provided comprised of a body 110 comprised of a first end 120 comprised of at least one coupling 122, a second end 130 comprised of at least one coupling 132, an interior space 140 comprised of at least one blade 142, at least one motor 150, and at least one mobile application 170 [Step 402]. Then, the first end 120 and second end 130 can be attached in-line with a pipe system (via the couplings 122,132) such that the body 110 is in fluid communication with the pipe system [Step 404]. Then, the motor 150 can be activated and/or programmed to spin the blade 142 during specific time intervals via the mobile application 170 [Step 406].

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “pipe clog-clearing device” and “device” are interchangeable and refer to the pipe clog-clearing device 100 of the present invention.

Notwithstanding the forgoing, the pipe clog-clearing device 100 of the present invention and its various components can be of any suitable size and configuration as is known in the art without affecting the overall concept of the invention, provided that they accomplish the above-stated objectives. One of ordinary skill in the art will appreciate that the size, configuration, and material of the pipe clog-clearing device 100 as shown in the FIGS. are for illustrative purposes only, and that many other sizes and shapes of the pipe clog-clearing device 100 are well within the scope of the present disclosure. Although the dimensions of the pipe clog-clearing device 100 are important design parameters for user convenience, the pipe clog-clearing device 100 may be of any size, shape, and/or configuration that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A pipe clog-clearing device comprising:
a body comprised of a first end comprised of a first coupling, a second end comprised of a second coupling, and an interior space;
a blade positioned within the interior space, the blade comprised of an axle; and
a motor.

2. The pipe clog-clearing device of claim 1, wherein the first coupling and the second coupling are comprised of a rigid coupling, a flexible coupling, a slip coupling, a compression coupling, a flange coupling, a sleeve coupling, a grooved coupling, a hydraulic coupling, a bell and spigot coupling, or a union coupling.

3. The pipe clog-clearing device of claim 1, wherein the blade is comprised of a cutting edge.

4. The pipe clog-clearing device of claim 1, wherein the blade can rotate 360 degrees around the axle relative to a vertical axis of the body.

5. The pipe clog-clearing device of claim 1, wherein the blade is comprised of a metal material.

6. The pipe clog-clearing device of claim 1 further comprised of a timer that activates the motor on a programmable time interval.

7. A pipe clog-clearing device comprising:
a body comprised of a first end comprised of a first coupling, a second end comprised of a second coupling, and an interior space;
a blade positioned within the interior space, the blade comprised of an axle; and
a motor; and
a receiver.

8. The pipe clog-clearing device of claim 7, wherein the first coupling and the second coupling are comprised of a rigid coupling, a flexible coupling, a slip coupling, a compression coupling, a flange coupling, a sleeve coupling, a grooved coupling, a hydraulic coupling, a bell and spigot coupling, or a union coupling.

9. The pipe clog-clearing device of claim 7, wherein the blade is comprised of a cutting edge.

10. The pipe clog-clearing device of claim 7, wherein the blade can rotate 360 degrees around the axle relative to a vertical axis of the body.

11. The pipe clog-clearing device of claim 7, wherein the blade is comprised of a metal material.

12. The pipe clog-clearing device of claim 7 further comprised of a timer that activates the motor on a programmable time interval.

13. The pipe clog-clearing device of claim 7 further comprised of a remote in wireless electrical communication with the receiver.

14. The pipe clog-clearing device of claim 13, wherein the remote controls the activation of the motor.

15. The pipe clog-clearing device of claim 7 further comprised of a mobile application.

16. The pipe clog-clearing device of claim 15, wherein the mobile application controls the activation of the motor.

17. The pipe clog-clearing device of claim 16, wherein the activation of the motor can be programmed on a time interval.

18. A method of using a pipe clog-clearing device, the method comprising the following steps:
providing a pipe clog-clearing device comprised of a body comprised of a first end comprised of first coupling, a second end comprised of a second, an interior space comprised of a blade, and a motor;
attaching the first end and the second end to a pipe system; and
programming the motor to spin the blade.

19. The method of using a pipe clog-clearing device of claim 18, wherein the motor is programmed to spin the blade on a time interval.

20. The method of using a pipe clog-clearing device of claim 18, wherein the blade is comprised of a cutting edge.
